(19) United States
(12) Patent Application Publication
(10) Pub. No.: US 2026/0044315 A1
(43) Pub. Date: Feb. 12, 2026

(54) COMPUTER USER INTERFACE TO DISPLAY WHAT PAGES A PARTICULAR ASSET IN "USED IN"

(71) Applicant: Shopify Inc., Ottawa (CA)

(72) Inventors: Matthew David Koenig, Bellevue, WA (US); Gurpreet Gill, Caledon (CA); Richard Monette, Ottawa (CA); Guduru Sai Nihas, Toronto (CA); Stephan Leroux, East Gwillimbury (CA)

(21) Appl. No.: 18/795,844

(22) Filed: Aug. 6, 2024

(51) Int. Cl. G06F 8/34

(52) U.S. Cl. CPC G06F 8/34

(57) ABSTRACT

Systems and methods are disclosed herein for providing a Graphical User Interface (GUI) for a website builder software platform that includes a “used in” feature for digital assets used in blocks within the website. More specifically, digital assets are associated to blocks in which the digital assets are used within the website. Information about these associations is dynamically updated and displayed via the GUI. In this manner, a website creator can quickly and easily see that a particular digital asset is used in certain blocks and take this information into account when, e.g., updating that digital asset.

### TECHNICAL FIELD

The present disclosure relates to an online website builder platform.

### BACKGROUND

Website builders are software systems that enable users to quickly and easily build and edit a website. These website builders are oftentimes implemented as online platforms where a user uses a configuration website to build and edit the user's website that is then hosted by the same online platform.

### SUMMARY

Systems and methods are disclosed herein for providing a Graphical User Interface (GUI) for a website builder software platform that includes a “used in” feature for digital assets used in blocks within the website. More specifically, digital assets are associated to blocks in which the digital assets are used within the website. Information about these associations is dynamically updated and displayed via the GUI. In this manner, a website creator can quickly and easily see that a particular digital asset is used in certain blocks and take this information into account when, e.g., updating that digital asset.

In one embodiment, a computer-implemented method comprises storing a plurality of digital assets for use in blocks of a website and, for a digital asset from among the plurality of digital assets, storing data indicative of one or more blocks of the website that use the digital asset. The method further comprises generating data representative of a GUI for a website builder function for building the website, the GUI comprising a first GUI element that represents the digital asset and one or more second GUI elements that are associated with the first GUI element and are indicative of the one or more blocks of the website that use the digital asset.

In one embodiment, the method further comprises, for the digital asset, updating the data indicative of the one or more blocks of the website that use the digital asset to add an additional block of the website that uses the digital asset. The method further comprises updating the data representative of the GUI for the website builder function for editing the website such that the one or more second GUI elements are further indicative of the additional block of the website that uses the digital asset. In one embodiment, the method further comprises receiving input that causes the digital asset to be used in the additional block of the website, wherein updating that data representative of the GUI for the website builder function for editing the website such that the one or more second GUI elements are further indicative of the additional block of the website that uses the digital asset is performed responsive to the digital asset being used in the additional block of the website.

In one embodiment, the method further comprises sending the data representative of the GUI for the website builder function to a remote device to cause the GUI to be presented on a display of the remote device.

In one embodiment, the method further comprises causing the GUI for the website builder function to be displayed in accordance with the data representative of the GUI for the website builder function.

In one embodiment, the one or more blocks of the website that use the digital asset comprise any one or more of the following: one or more webpages of the website, one or more meta-objects used in the website, and one or more blocks used in webpages of the website.

In one embodiment, the one or more blocks of the website comprise two or more types of blocks, and the one or more second GUI elements are indicative of the two or more types of blocks.

In one embodiment, the digital asset is a digital image, a digital video, a 3-Dimensional (3D) model, a point cloud, or a Gaussian splat.

Corresponding embodiments of a computing system are also disclosed.

### BRIEF DESCRIPTION OF THE DRAWINGS

Embodiments will be described, by way of example only, with reference to the accompanying figures wherein:

FIG. 1 illustrates a system including an online website builder platform in accordance with embodiments of the present disclosure.

FIG. 2 illustrates the operation of a website builder function to store and update data that associates digital assets to blocks in which those digital assets are used, in accordance with embodiments of the present disclosure.

FIG. 3 illustrates an example data structure that represents the data that associates the digital assets to the blocks in which those digital assets are used, in accordance with embodiments of the present disclosure.

FIG. 4 illustrates the operation of the website builder function to generate and provide a Graphical User Interface (GUI) in which “used in” data for the digital assets can be presented to a website creator, in accordance with embodiments of the present disclosure.

FIG. 5 shows one example of a GUI in which the website builder function provides “used in”data for a particular digital asset.

FIG. 6 illustrates an example e-commerce platform, according to one embodiment.

FIG. 7 depicts a non-limiting embodiment for a home page of an administrator.

Like reference numerals are used in the drawings to denote like elements and features.

### DETAILED DESCRIPTION OF EMBODIMENTS

There are certain problems with existing online website builder platforms. When building and editing a website via an online website builder platform, a user (i.e., the website creator) uploads many digital assets (e.g., images, videos, 3-Dimensional (3D) models, etc.) to the user's allocated storage on the online website builder platform, and these digital assets are then used in the user's website. Oftentimes, the same digital asset may be used multiple times in the user's website. For example, the same digital image may be used on multiple “blocks” that may then be used in the user's website. Note that a “block” is a term of art in modern Content Management Systems (CMSs). In these contexts, a “block” refers to a distinct section or component of a webpage that can be independently managed, edited, and styled. Blocks are used to build and customize page layouts in a modular fashion. Each block can contain different types of content such as text, image(s), video(s), buttons, widgets, and/or other interactive elements. Further, the same block may reused multiple times within the website. Thus, for example, the same digital image may be used in different blocks using different image settings (e.g., used in in a first block on a first webpage as a large size image and used in a second block on a second webpage as a thumbnail size image). Thus, it would be beneficial for the user to be able to quickly learn all blocks in which a particular digital asset is used in the user's website, e.g., before editing that digital asset as the edit may not be desirable in all blocks in which the digital asset is used in the website.

Systems and methods are disclosed herein that address the aforementioned problems with existing online website builder platforms. In particular, embodiments of a computer-implemented method for providing a Graphical User Interface (GUI) for a website builder software platform that includes a “used in” feature for digital assets used in blocks within the website are disclosed. More specifically, digital assets are associated to blocks in which the digital assets are used within the website. Information about these associations is displayed via the GUI. In this manner, the website creator can quickly and easily see that a particular digital asset is used in certain blocks and take this information into account when, e.g., updating that digital asset.

It should be noted that embodiments of the present disclosure are to be differentiated from the existing Hyper-Text Transfer Protocol (HTTP) referrer mechanism used when rendering webpages. The HTTP referrer mechanism is a mechanism in which HTTP referrer headers are used, e.g., in <IMG> embeds and <A> links, to identify the address of the webpage (i.e., the Uniform Resource Indicator (URI) or Internationalized Resource Identifier (IRI)) from which a digital asset has been requested. In other words, when a webpage including an embedded image is rendered by a web browser, the web browser includes the HTTP referrer header in the request for the embedded image sent to the server, where the HTTP referrer header includes the address of the webpage being rendered and for which the image is being requested. The HTTP referrer mechanism thus relates to rendering webpages and thus can only be used to track what visited webpages/URIs/IRIs have requested a digital asset. The HTTP referrer mechanism is not suitable for use in a website builder software platform to track which webpages within the website use a digital asset, let alone to track what blocks used to build the website use a digital asset. For instance, if certain webpages within the website have not been visited (e.g., because the website is not yet “live” or because no one has yet visited those webpages), then the HTTP referrer mechanism would fail to indicate that those webpages use the digital asset. Further, maintaining a list of blocks that use a digital asset is much more valuable than a list of webpages (URI or IRIs) that use the digital asset. For example, the same block using a particular digital asset may be reused on multiple webpages within the website. The HTTP referrer mechanism would show this as the image being rendered on multiple different webpages, whereas embodiments of the present disclosure would show this digital asset as being used in a single block, where this block is reused in multiple webpages.

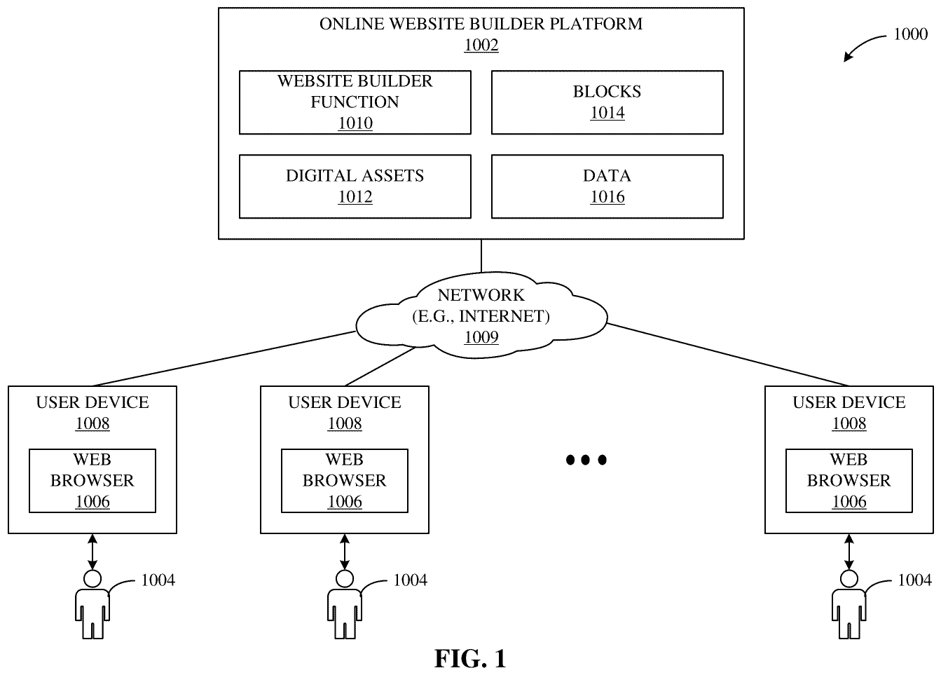

Now, turning to a more detailed description of embodiments of the present disclosure, FIG. 1 illustrates a system 1000 including an online website builder platform 1002 in accordance with embodiments of the present disclosure. The online website builder platform 1002 may be implemented in any suitable type of computing environment such as, e.g., a server computer, a distributed network of server computers that operate in a collaborative manner (e.g., for load sharing and/or redundancy), a virtualized computing environment (e.g., a virtual computing system, container, or the like), or the like. The online website builder platform 1002 enables website creators 1004 (i.e., users) to interact with the online website builder platform 1002 via web browsers 1006 operating on their user devices 1008 (e.g., personal computers, tablet computers, smart phones, or the like) over a network 1009 to create websites that are then either hosted by the online website builder platform 1002 or hosted by a third-party hosting service.

The online website builder platform 1002 includes a website builder function 1010, which is preferably implemented in software and provides the functionality needed to enable the website creators 1004 to create their websites. For each website, the online website builder platform 1002 stores digital assets 1012 available for use in the website, blocks 1014 used in the website where each block may use (e.g., include or include Uniform Resource Locator(s) (URL(s)) or URI(s) linking to) one or more of the digital assets 1012, and data 1016 (e.g., stored in a table or database) that associates the digital assets 1012 to the blocks 1014 in which those digital assets 1012 are used. The data 1016 is also referred to herein as “used in” data for the digital assets 1012 (i.e., data indicative of the blocks 1014 in which the digital assets 1012 are used). The digital assets 1012 may be uploaded to the online website builder platform 1002 by the website creator 1004.

The digital assets 1012 may include images (e.g., digital photographs), videos, 3D models, and/or the like). Note that, in regard to images (e.g., digital photographs) and digital videos, the images and/or videos may be taken using a digital camera, where, for example, the digital camera may be integrated into (e.g., be a component of) the user device 1008 or may be separate from the user device 1008 in which case the digital images and/or videos may be communicated from the digital camera to the user device 1008 via a direct wired or wireless communication link (e.g., a Universal Serial Bus (USB) connection or Bluetooth connection) or via a remote communication link (e.g., a communication link established over a private or public network such as, e.g. the Internet, which passes through one or more intermediaries (e.g., a network node, a network, a computer, or the like)).

The blocks 1014 may be predefined blocks (e.g., in a website template) or custom blocks created by the website creator 1004 using the website builder function 1010 (e.g., using predefined templates). The blocks 1014 are distinct sections or components of a webpage that can be independently managed, edited, and styled. The blocks 1014 are used to build and customize webpage layouts with the website in a modular fashion. Each block 1014 can contain different types of content such as, e.g., text, one or more images, one or more videos, one or more buttons, one or more widgets, and/or other interactive element(s). The blocks 1014 can be edited by the website creator 1004 via the website builder function 1010 to, e.g., use one or more of the digital assets 1012 (e.g., one or more images (i.e., one or more digital photographs), one or more videos, one or more 3D models, and/or the like) in the blocks 1014 or to remove digital assets 1012 from being used in the blocks 1014. In the context of an e-commerce website, for example, the blocks 1014 may include multiple product blocks representative of products sold or advertised via the e-commerce website, where each product block includes a digital photograph of the product. Other examples of a block 1014 include, but are not limited to, a webpage, a web article, a blog, a post on a webpage (e.g., a blog post on a blog), a meta-object (e.g., a metafield), an email for an email campaign, a search result page, or the like. Note that, in regard to “meta-objects,” a meta-object is an object that contains data about some entity associated with the website. For example, the website may include webpages that contain articles written by various authors or blog posts written by various authors, where a meta-object may be created by the website creator for each author and contain data about the author such as, e.g., the author's name, a picture (which is a digital asset) of the author, etc. This picture of the author is stored as a digital asset of the website, and the meta-object of the author is a core resource of the website which may be included in each article/webpage/post written by that author. Other examples of a meta-object include a meta-object containing data about a registered user of the website, a meta-object containing data about a customer registered with the website (e.g., in the case of an e-commerce website), or the like.

The data 1016 is maintained by the website builder function 1010 and updated as digital assets 1012 that are used and/or removed from the blocks 1014 and/or as new blocks 1014 are created using the digital assets 1012, as described below.

The website builder function 1010 provides, to the website creator 1004 via the web browser 1006 operating on the user device 1008 of the website creator 1004, a GUI that enables the website creator 1004 to interact with the website builder function 1010 to create the website. In accordance with embodiments of the present disclosure, within this GUI, the website builder function 1010 provides “used in” data to the website creator 1004, i.e. for a digital asset 1012, and presents, within the GUI, a first GUI element that represents the digital asset 1012 (e.g., a file name of the digital asset in a list of digital assists) and one or more second GUI elements that are associated with the first GUI element and are indicative of one or more blocks 1014 that use this digital asset 1012.

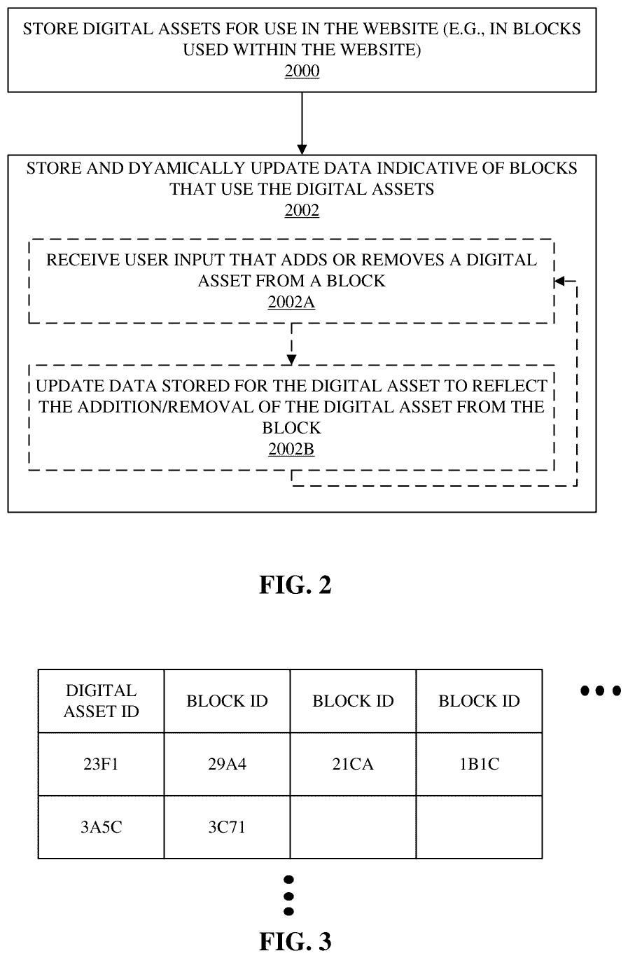

FIG. 2 illustrates the operation of the website builder function 1010 to store and update the data 1016 that associates the digital assets 1012 to the blocks 1014 in which those digital assets 1012 are used, in accordance with embodiments of the present disclosure. Optional steps are represented by dashed lines or boxes. As illustrated, the website builder function 1010 stores the digital assets 1012 for use in the website (step 2000). While illustrated as a single step, it is to be understood that the process of storing the digital assets 1012 may be repeated as the website creator 1004 adds (e.g., uploads) new digital assets 1012. The website builder function 1010 stores and dynamically updates the data 1016 that associates the digital assets 1012 to the blocks 1014 in which those digital assets 1012 are used (step 2002). In other words, as the website creator 1004 adds digital assets 1012 to blocks 1014 and removes digital assets 1012 from blocks 1014, the website builder function 1010 updates the data 1016 to reflect the addition or removal of the digital assets 1012 to/from the blocks 1014. For example, in one embodiment, the website builder function 1010 receives user input that causes the website builder function 1010 to either add a digital asset 1012 to a block 1014 or remove a digital asset 1012 from a block 1014 (step 2002A). In response to the digital asset 1012 being added or removed from the block 1014, the website builder function 1010 updates the data 1016 to either associate the digital asset 1012 to the block 1014 (in the case that the user input caused the website builder function 1010 to add the digital asset 1012 to the block 1014) or remove an existing association of the digital asset 1012 from the block 1014 (in the case that the user input caused the website builder function 1010 to remove the digital asset 1012 from the block 1014) (step 2002B). Steps 2002A and 2002B are repeated as digital assets 1012 are used or removed from the blocks 1014.

Note that while the description herein focuses on blocks 1014, the present disclosure is not limited thereto. The process of FIG. 2 may additionally or alternatively be used to store and update the data 1016 to associate the digital assets 1012 to any type of database entity, which may include database entities that are used in the website. In the context of an e-commerce website, these database entities may include, for example, database entities that represent products sold via the website, collections of products sold via the website, customers, orders, email campaigns, emails, brand settings, a meta-field tied to a customer for back office use cases, etc.

FIG. 3 illustrates an example data structure that represents the data 1016 that associates the digital assets 1012 to the blocks 1014 in which those digital assets 1012 are used, in accordance with embodiments of the present disclosure. In this example, each digital asset 1012 is assigned a unique digital asset Identifier (ID), and each block 1014 is assigned a unique block ID. The data structure is a table including a first column containing digital asset IDs of the digital assets 1012 and multiple additional columns that contain, for each digital asset ID, a list of block IDs of the blocks 1014 in which the corresponding digital asset 1012 is used. This table is updated via the process of FIG. 2.

Again, note that while the description herein focuses on blocks 1014, the present disclosure is not limited thereto. The example data structure of FIG. 3 may additionally or alternatively be used to store, for each digital asset ID, one or more database entity IDs of database entities in which that digital asset is used.

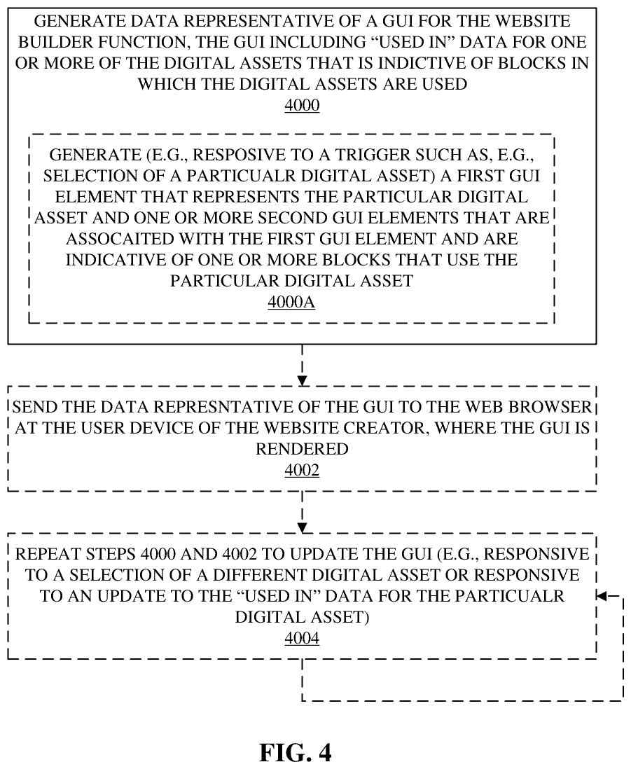

FIG. 4 illustrates the operation of the website builder function 1010 to generate and provide a GUI in which the “used in” data 1016 for the digital assets 1012 can be presented to the website creator 1004, in accordance with embodiments of the present disclosure. Optional steps are represented by dashed lines or boxes. Note that the process of FIG. 4 may be provided within the context of a file editor or similar functionality of the website builder function 1010 (or that is invoked by the website builder 1010). As illustrated, the website builder function 1010 generates data representative of the GUI for the website builder function 1010, where the GUI includes the “used in” data 1016 for one or more of the digital assets 1012 that is indicative of one of more of the blocks 1014 in which the digital asset 1012 is used (step 4000). This generated data is the data 1016 that is sent (e.g., in step 4002) to the web browser 1006 at the user device 1008 of the website creator 1004, where the web browser 1006 processes this data 1016 to render the GUI at the user device 1008. In one embodiment, the data 1016 representative of the GUI is generated in step 4000 such that the GUI includes a first GUI element that represents a particular digital asset 1012 and one or more second GUI elements that are associated with the first GUI element and are indictive of the one or more blocks 1014 that use the particular digital asset 1012, as indicated by the data 1016 (step 4000A). In other words, the one or more second GUI elements represent the “used in” data 1016 for that particular digital asset 1012.

The first GUI element that represents the particular digital asset 1012 may be, for example, text corresponding to a file name of the digital asset 1012, the image in the event that the particular digital asset 1012 is an image, a frame of the video in the event that the particular digital asset 1012 is a video, or the like. The one or more second GUI elements may provide a listing of the blocks 1014 in which the particular digital asset 1012 is used, provide separate listings of the blocks 1014 in which the particular digital asset 1012 is used for one or more block types or categories, or the like. For example, the one or more second GUI elements may include, for example, a pop-up window or side-bar that includes text or other elements that are indicative of the block(s) 1014 in which the particular digital asset 1012 is used. The one or more second GUI elements may, for example, be a list of block IDs, a list of text descriptors of the blocks 1014, elements that represent one or more block types or categories that can be further selected to view the particular blocks 1014 of that type or category that use the particular digital asset 1012, or the like. In some embodiments, the one or more second GUI elements include a separate GUI element (e.g., a text-based GUI element) for each block 1014 in which the digital asset 1012 is used, where these GUI elements are selectable by the website creator 1004 to view a listing or other data that indicates each place (e.g., each webpage) within the website that the selected block 1014 is located.

The website builder function 1010 sends the data 1016 that represents the GUI to the web browser 1006 at the user device 1008 of the website creator 1004, where this data 1016 is processed by the web browser 1006 to render the GUI (step 4002). Note that, in this example, the web browser 1006 renders the GUI on a display at the user device 1008. However, in an alternative embodiment, the website builder function 1010 causes the GUI to be displayed on an associated display or on a display of a remote device (e.g., the user device 1008).

Steps 4000 and 4002 may be repeated to update the GUI, e.g., responsive to a selection of a different digital asset 1012 by the website creator 1004 in the GUI or responsive to an update to the “used in” data 1016 of the (selected) particular digital asset 1012 (step 4004).

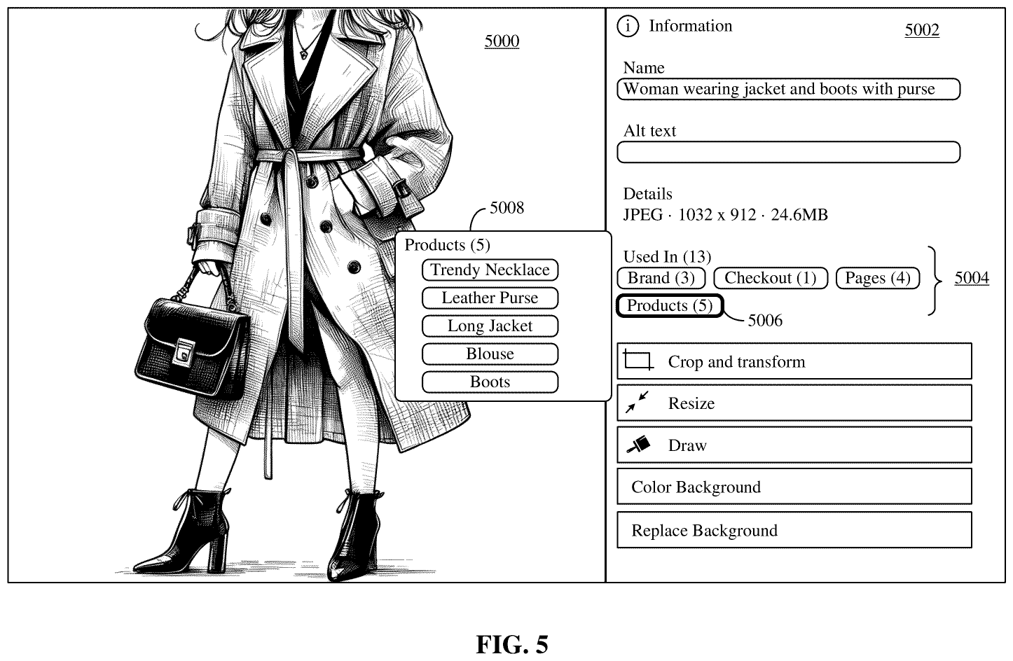

For illustration, FIG. 5 shows one example of a GUI in which the website builder function 1010 provides “used in” data for a particular digital asset 1012. Again, this GUI may be provided within the context of a file editor or similar functionality of the website builder function 1010 (or that is invoked by the website builder 1010). In this example, the website is an e-commerce store, and the particular digital asset 1012 is an image (i.e., a digital photograph) of a woman wearing multiple products being sold via the e-commerce store, namely, a trendy necklace, a leather purse, a long jacket, a blouse, and boots. In this example, the website creator 1004 has selected the image (not shown, but could be, for example, selecting the image from a list of images). In response, the GUI presents a first GUI element 5000 representative of the image, where in this example the first GUI element 5000 is the image itself, and a sidebar 5002 (i.e., a second GUI element) that presents “used in” data 5004 for the selected image. In this example, the sidebar 5002 includes the “used in” data 5004 for the selected image. Further, in this example, the “used in” data 5004 for the selected image indicates that the image is used in thirteen (13) blocks 1014, where these thirteen (13) blocks 1014 in which the image is used are divided into multiple categories, i.e., a “Brand” category including in this example three (3) of the thirteen (13) blocks, a “Checkout” category including in this example one (1) of the thirteen (13) blocks, a “Pages” category including in this example four (4) of the thirteen (13) blocks, and a “Products” category including in this example five (5) of the thirteen (13) blocks. In this example, the website creator 1004 has selected (e.g., “clicked on”) a GUI element 5006 representing the “Products” category and, in response, a GUI element 5008 containing a listing of the five (5) blocks 1014 within the “Products” category (i.e., the five (5) Product blocks) that use the digital image is presented. The GUI may further enable the website creator 1004 to select an item in the list of Product blocks to further view a listing of webpages within the website that use the selected Product block.

The following example e-commerce platform is one example of a system in which the above-described embodiments may be implemented in respect to building an e-commerce website.

### Example E-Commerce Platform

Although integration with a commerce platform is not required, in some embodiments, the methods disclosed herein may be performed on or in association with a commerce platform such as an e-commerce platform. Therefore, an example of a commerce platform will be described.

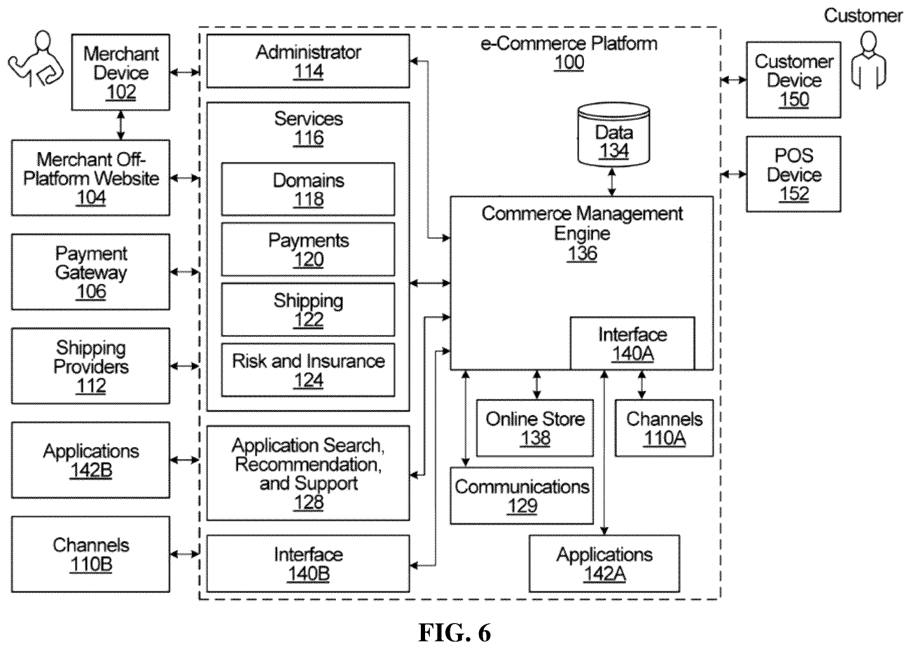

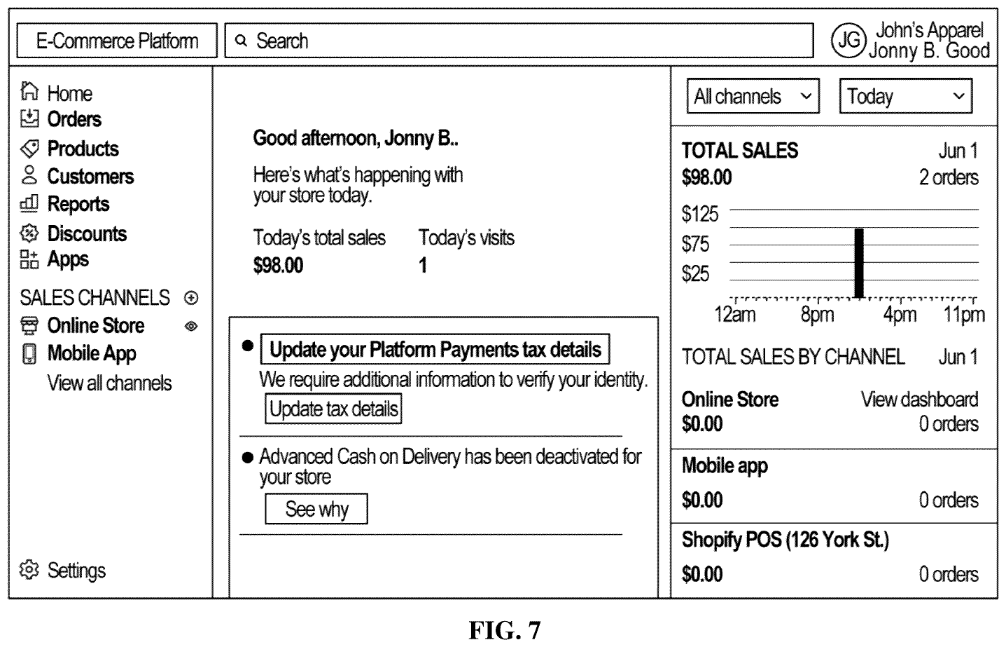

FIG. 6 illustrates an example e-commerce platform 100, according to one embodiment. The e-commerce platform 100 may be exemplary of the e-commerce platform 105 described with reference to FIG. 7. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including, for example, physical products, digital content (e.g., music, videos, games), software, tickets, subscriptions, services to be provided, and the like.

While the disclosure throughout contemplates that a “merchant” and a “customer” may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to “merchants” and “customers”, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, consumer, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like. Furthermore, it may be recognized that while a given user may act in a given role (e.g., as a merchant) and their associated device may be referred to accordingly (e.g., as a merchant device) in one context, that same individual may act in a different role in another context (e.g., as a customer) and that same or another associated device may be referred to accordingly (e.g., as a customer device). For example, an individual may be a merchant for one type of product (e.g., shoes), and a customer/consumer of other types of products (e.g., groceries). In another example, an individual may be both a consumer and a merchant of the same type of product. In a particular example, a merchant that trades in a particular category of goods may act as a customer for that same category of goods when they order from a wholesaler (the wholesaler acting as merchant).

The e-commerce platform 100 provides merchants with online services/facilities to manage their business. The facilities described herein are shown implemented as part of the platform 100 but could also be configured separately from the platform 100, in whole or in part, as stand-alone services. Furthermore, such facilities may, in some embodiments, may, additionally or alternatively, be provided by one or more providers/entities.

In the example of FIG. 6, the facilities are deployed through a machine, service or engine that executes computer software, modules, program codes, and/or instructions on one or more processors which, as noted above, may be part of or external to the platform 100. Merchants may utilize the e-commerce platform 100 for enabling or managing commerce with customers, such as by implementing an e-commerce experience with customers through an online store 138, applications 142A-B, channels 110A-B, and/or through point-of-sale (POS) devices 152 in physical locations (e.g., a physical storefront or other location such as through a kiosk, terminal, reader, printer, 3D printer, and the like).

A merchant may utilize the e-commerce platform 100 as a sole commerce presence with customers, or in conjunction with other merchant commerce facilities, such as through a physical store (e.g., “brick-and-mortar” retail stores), a merchant off-platform website 104 (e.g., a commerce Internet website or other internet or web property or asset supported by or on behalf of the merchant separately from the e-commerce platform 100), an application 142B, and the like. However, even these “other” merchant commerce facilities may be incorporated into or communicate with the e-commerce platform 100, such as where POS devices 152 in a physical store of a merchant are linked into the e-commerce platform 100, where a merchant off-platform website 104 is tied into the e-commerce platform 100, such as, for example, through “buy buttons” that link content from the merchant off platform website 104 to the online store 138, or the like.

The online store 138 may represent a multi-tenant facility comprising a plurality of virtual storefronts. In embodiments, merchants may configure and/or manage one or more storefronts in the online store 138, such as, for example, through a merchant device 102 (e.g., computer, laptop computer, mobile computing device, and the like), and offer products to customers through a number of different channels 110A-B (e.g., an online store 138; an application 142A-B; a physical storefront through a POS device 152; an electronic marketplace, such, for example, through an electronic buy button integrated into a website or social media channel such as on a social network, social media page, social media messaging system; and/or the like). A merchant may sell across channels 110A-B and then manage their sales through the e-commerce platform 100, where channels 110A may be provided as a facility or service internal or external to the e-commerce platform 100. A merchant may, additionally or alternatively, sell in their physical retail store, at pop ups, through wholesale, over the phone, and the like, and then manage their sales through the e-commerce platform 100. A merchant may employ all or any combination of these operational modalities. Notably, it may be that by employing a variety of and/or a particular combination of modalities, a merchant may improve the probability and/or volume of sales. Throughout this disclosure the terms online store 138 and storefront may be used synonymously to refer to a merchant's online e-commerce service offering through the e-commerce platform 100, where an online store 138 may refer either to a collection of storefronts supported by the e-commerce platform 100 (e.g., for one or a plurality of merchants) or to an individual merchant's storefront (e.g., a merchant's online store).

In some embodiments, a customer may interact with the platform 100 through a customer device 150 (e.g., computer, laptop computer, mobile computing device, or the like), a POS device 152 (e.g., retail device, kiosk, automated (self-service) checkout system, or the like), and/or any other commerce interface device known in the art. The e-commerce platform 100 may enable merchants to reach customers through the online store 138, through applications 142A-B, through POS devices 152 in physical locations (e.g., a merchant's storefront or elsewhere), to communicate with customers via electronic communication facility 129, and/or the like so as to provide a system for reaching customers and facilitating merchant services for the real or virtual pathways available for reaching and interacting with customers.

In some embodiments, and as described further herein, the e-commerce platform 100 may be implemented through a processing facility. Such a processing facility may include a processor and a memory. The processor may be a hardware processor. The memory may be and/or may include a non-transitory computer-readable medium. The memory may be and/or may include random access memory (RAM) and/or persisted storage (e.g., magnetic storage). The processing facility may store a set of instructions (e.g., in the memory) that, when executed, cause the e-commerce platform 100 to perform the e-commerce and support functions as described herein. The processing facility may be or may be a part of one or more of a server, client, network infrastructure, mobile computing platform, cloud computing platform, stationary computing platform, and/or some other computing platform, and may provide electronic connectivity and communications between and amongst the components of the e-commerce platform 100, merchant devices 102, payment gateways 106, applications 142A-B, channels 110A-B, shipping providers 112, customer devices 150, point-of-sale devices 152, etc. In some implementations, the processing facility may be or may include one or more such computing devices acting in concert. For example, it may be that a plurality of co-operating computing devices serves as/to provide the processing facility. The e-commerce platform 100 may be implemented as or using one or more of a cloud computing service, software as a service (SaaS), infrastructure as a service (IaaS), platform as a service (PaaS), desktop as a service (DaaS), managed software as a service (MSaaS), mobile backend as a service (MBaaS), information technology management as a service (ITMaaS), and/or the like. For example, it may be that the underlying software implementing the facilities described herein (e.g., the online store 138) is provided as a service, and is centrally hosted (e.g., and then accessed by users via a web browser or other application, and/or through customer devices 150, POS devices 152, and/or the like). In some embodiments, elements of the e-commerce platform 100 may be implemented to operate and/or integrate with various other platforms and operating systems.

In some embodiments, the facilities of the e-commerce platform 100 (e.g., the online store 138) may serve content to a customer device 150 (using data 134) such as, for example, through a network connected to the e-commerce platform 100. For example, the online store 138 may serve or send content in response to requests for data 134 from the customer device 150, where a browser (or other application) connects to the online store 138 through a network using a network communication protocol (e.g., an internet protocol). The content may be written in machine readable language and may include Hypertext Markup Language (HTML), template language, JavaScript, and the like, and/or any combination thereof.

In some embodiments, online store 138 may be or may include service instances that serve content to customer devices and allow customers to browse and purchase the various products available (e.g., add them to a cart, purchase through a buy-button, and the like). Merchants may also customize the look and feel of their website through a theme system, such as, for example, a theme system where merchants can select and change the look and feel of their online store 138 by changing their theme while having the same underlying product and business data shown within the online store's product information. It may be that themes can be further customized through a theme builder, a design interface that enables users to customize their website's design with flexibility. Additionally, or alternatively, it may be that themes can, additionally or alternatively, be customized using theme-specific settings such as, for example, settings as may change aspects of a given theme, such as, for example, specific colours, fonts, and pre-built layout schemes. In some implementations, the online store may implement a content management system for website content. Merchants may employ such a content management system in authoring blog posts or static pages and publish them to their online store 138, such as through blogs, articles, landing pages, and the like, as well as configure navigation menus. Merchants may upload images (e.g., for products), video, content, data, and the like to the e-commerce platform 100, such as for storage by the system (e.g., as data 134). In some embodiments, the e-commerce platform 100 may provide functions for manipulating such images and content such as, for example, functions for resizing images, associating an image with a product, adding and associating text with an image, adding an image for a new product variant, protecting images, and the like.

As described herein, the e-commerce platform 100 may provide merchants with sales and marketing services for products through a number of different channels 110A-B, including, for example, the online store 138, applications 142A-B, as well as through physical POS devices 152 as described herein. The e-commerce platform 100 may, additionally or alternatively, include business support services 116, an administrator 114, a warehouse management system, and the like associated with running an on-line business, such as, for example, one or more of providing a domain registration service 118 associated with their online store, payment facility 120 for facilitating transactions with a customer, shipping services 122 for providing customer shipping options for purchased products, fulfillment services for managing inventory, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may be configured with shipping services 122 (e.g., through an e-commerce platform shipping facility or through a third-party shipping carrier), to provide various shipping-related information to merchants and/or their customers such as, for example, shipping label or rate information, real-time delivery updates, tracking, and/or the like.

FIG. 7 depicts a non-limiting embodiment for a home page of an administrator 114. The administrator 114 may be referred to as an administrative console and/or an administrator console. The administrator 114 may show information about daily tasks, a store's recent activity, and the next steps a merchant can take to build their business. In some embodiments, a merchant may log in to the administrator 114 via a merchant device 102 (e.g., a desktop computer or mobile device), and manage aspects of their online store 138, such as, for example, viewing the online store's 138 recent visit or order activity, updating the online store's 138 catalog, managing orders, and/or the like. In some embodiments, the merchant may be able to access the different sections of the administrator 114 by using a sidebar, such as the one shown on FIG. 7. Sections of the administrator 114 may include various interfaces for accessing and managing core aspects of a merchant's business, including orders, products, customers, available reports and discounts. The administrator 114 may, additionally or alternatively, include interfaces for managing sales channels for a store including the online store 138, mobile application(s) made available to customers for accessing the store (Mobile App), POS devices, and/or a buy button. The administrator 114 may, additionally or alternatively, include interfaces for managing applications (apps) installed on the merchant's account; and settings applied to a merchant's online store 138 and account. A merchant may use a search bar to find products, pages, or other information in their store.

More detailed information about commerce and visitors to a merchant's online store 138 may be viewed through reports or metrics. Reports may include, for example, acquisition reports, behavior reports, customer reports, finance reports, marketing reports, sales reports, product reports, and custom reports. The merchant may be able to view sales data for different channels 110A-B from different periods of time (e.g., days, weeks, months, and the like), such as by using drop-down menus. An overview dashboard may also be provided for a merchant who wants a more detailed view of the store's sales and engagement data. An activity feed in the home metrics section may be provided to illustrate an overview of the activity on the merchant's account. For example, by clicking on a “view all recent activity” dashboard button, the merchant may be able to see a longer feed of recent activity on their account. A home page may show notifications about the merchant's online store 138, such as based on account status, growth, recent customer activity, order updates, and the like. Notifications may be provided to assist a merchant with navigating through workflows configured for the online store 138, such as, for example, a payment workflow, an order fulfillment workflow, an order archiving workflow, a return workflow, and the like.

The e-commerce platform 100 may provide for a communications facility 129 and associated merchant interface for providing electronic communications and marketing, such as utilizing an electronic messaging facility for collecting and analyzing communication interactions between merchants, customers, merchant devices 102, customer devices 150, POS devices 152, and the like, to aggregate and analyze the communications, such as for increasing sale conversions, and the like. For instance, a customer may have a question related to a product, which may produce a dialog between the customer and the merchant (or an automated processor-based agent/chatbot representing the merchant), where the communications facility 129 is configured to provide automated responses to customer requests and/or provide recommendations to the merchant on how to respond such as, for example, to improve the probability of a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between the e-commerce platform 100 and a merchant's bank account, and the like. The financial facility 120 may also provide merchants and buyers with financial support, such as through the lending of capital (e.g., lending funds, cash advances, and the like) and provision of insurance. In some embodiments, online store 138 may support a number of independently administered storefronts and process a large volume of transactional data on a daily basis for a variety of products and services. Transactional data may include any customer information indicative of a customer, a customer account or transactions carried out by a customer such as. for example, contact information, billing information, shipping information, returns/refund information, discount/offer information, payment information, or online store events or information such as page views, product search information (search keywords, click-through events), product reviews, abandoned carts, and/or other transactional information associated with business through the e-commerce platform 100. In some embodiments, the e-commerce platform 100 may store this data in a data facility 134. Referring again to FIG. 6, in some embodiments the e-commerce platform 100 may include a commerce management engine 136 such as may be configured to perform various workflows for task automation or content management related to products, inventory, customers, orders, suppliers, reports, financials, risk and fraud, and the like. In some embodiments, additional functionality may, additionally or alternatively, be provided through applications 142A-B to enable greater flexibility and customization required for accommodating an ever-growing variety of online stores, POS devices, products, and/or services. Applications 142A may be components of the e-commerce platform 100 whereas applications 142B may be provided or hosted as a third-party service external to e-commerce platform 100. The commerce management engine 136 may accommodate store-specific workflows and in some embodiments, may incorporate the administrator 114 and/or the online store 138.

Implementing functions as applications 142A-B may enable the commerce management engine 136 to remain responsive and reduce or avoid service degradation or more serious infrastructure failures, and the like.

Although isolating online store data can be important to maintaining data privacy between online stores 138 and merchants, there may be reasons for collecting and using cross-store data, such as, for example, with an order risk assessment system or a platform payment facility, both of which require information from multiple online stores 138 to perform well. In some embodiments, it may be preferable to move these components out of the commerce management engine 136 and into their own infrastructure within the e-commerce platform 100.

Platform payment facility 120 is an example of a component that utilizes data from the commerce management engine 136 but is implemented as a separate component or service. The platform payment facility 120 may allow customers interacting with online stores 138 to have their payment information stored safely by the commerce management engine 136 such that they only have to enter it once. When a customer visits a different online store 138, even if they have never been there before, the platform payment facility 120 may recall their information to enable a more rapid and/or potentially less-error prone (e.g., through avoidance of possible mis-keying of their information if they needed to instead re-enter it) checkout. This may provide a cross-platform network effect, where the e-commerce platform 100 becomes more useful to its merchants and buyers as more merchants and buyers join, such as because there are more customers who checkout more often because of the ease of use with respect to customer purchases. To maximize the effect of this network, payment information for a given customer may be retrievable and made available globally across multiple online stores 138.

For functions that are not included within the commerce management engine 136, applications 142A-B provide a way to add features to the e-commerce platform 100 or individual online stores 138. For example, applications 142A-B may be able to access and modify data on a merchant's online store 138, perform tasks through the administrator 114, implement new flows for a merchant through a user interface (e.g., that is surfaced through extensions/API), and the like. Merchants may be enabled to discover and install applications 142A-B through application search, recommendations, and support 128. In some embodiments, the commerce management engine 136, applications 142A-B, and the administrator 114 may be developed to work together. For instance, application extension points may be built inside the commerce management engine 136, accessed by applications 142A and 142B through the interfaces 140B and 140A to deliver additional functionality, and surfaced to the merchant in the user interface of the administrator 114.

In some embodiments, applications 142A-B may deliver functionality to a merchant through the interface 140A-B, such as where an application 142A-B is able to surface transaction data to a merchant (e.g., App: “Engine, surface my app data in the Mobile App or administrator 114”), and/or where the commerce management engine 136 is able to ask the application to perform work on demand (Engine: “App, give me a local tax calculation for this checkout”).

Applications 142A-B may be connected to the commerce management engine 136 through an interface 140A-B (e.g., through REST (REpresentational State Transfer) and/or GraphQL APIs) to expose the functionality and/or data available through and within the commerce management engine 136 to the functionality of applications. For instance, the e-commerce platform 100 may provide API interfaces 140A-B to applications 142A-B which may connect to products and services external to the platform 100. The flexibility offered through use of applications and APIs (e.g., as offered for application development) enable the e-commerce platform 100 to better accommodate new and unique needs of merchants or to address specific use cases without requiring constant change to the commerce management engine 136. For instance, shipping services 122 may be integrated with the commerce management engine 136 through a shipping or carrier service API, thus enabling the e-commerce platform 100 to provide shipping service functionality without directly impacting code running in the commerce management engine 136.

Depending on the implementation, applications 142A-B may utilize APIs to pull data on demand (e.g., customer creation events, product change events, or order cancelation events, etc.) or have the data pushed when updates occur. A subscription model may be used to provide applications 142A-B with events as they occur or to provide updates with respect to a changed state of the commerce management engine 136. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some embodiments, update events may be queued and processed asynchronously from a state change that triggered them, which may produce an update event notification that is not distributed in real-time or near-real time.

In some embodiments, the e-commerce platform 100 may provide one or more of application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, and the like. In some embodiments, applications 142A-B may be assigned an application identifier (ID), such as for linking to an application (e.g., through an API), searching for an application, making application recommendations, and the like.

Applications 142A-B may be grouped roughly into three categories: customer-facing applications, merchant-facing applications, integration applications, and the like. Customer-facing applications 142A-B may include an online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways 106.

As such, the e-commerce platform 100 can be configured to provide an online shopping experience through a flexible system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products through a number of different channels 110A-B such as, for example, the merchant's online store 138, a physical storefront through a POS device 152; an electronic marketplace, through an electronic buy button integrated into a website or a social media channel). In some cases, channels 110A-B may be modeled as applications 142A-B. A merchandising component in the commerce management engine 136 may be configured for creating, and managing product listings (using product data objects or models for example) to allow merchants to describe what they want to sell and where they sell it. The association between a product listing and a channel may be modeled as a product publication and accessed by channel applications, such as via a product listing API. A product may have many attributes and/or characteristics, like size and colour, and many variants that expand the available options into specific combinations of all the attributes, like a variant that is size extra-small and green, or a variant that is size large and blue. Products may have at least one variant (e.g., a “default variant”) created for a product without any options. To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Product listings may include 2D images, 3D images or models, which may be viewed through a virtual or augmented reality interface, and the like.

In some embodiments, a shopping cart object is used to store or keep track of the products that the customer intends to buy. The shopping cart object may be channel specific and can be composed of multiple cart line items, where each cart line item tracks the quantity for a particular product variant. Since adding a product to a cart does not imply any commitment from the customer or the merchant, and the expected lifespan of a cart may be in the order of minutes (not days), cart objects/data representing a cart may be persisted to an ephemeral data store.

The customer then proceeds to checkout. A checkout object or page generated by the commerce management engine 136 may be configured to receive customer information to complete the order such as the customer's contact information, billing information and/or shipping details. If the customer inputs their contact information but does not proceed to payment, the e-commerce platform 100 may (e.g., via an abandoned checkout component) transmit a message to the customer device 150 to encourage the customer to complete the checkout. For those reasons, checkout objects can have much longer lifespans than cart objects (hours or even days) and may therefore be persisted. Customers then pay for the content of their cart resulting in the creation of an order for the merchant. In some embodiments, the commerce management engine 136 may be configured to communicate with various payment gateways and services 106 (e.g., online payment systems, mobile payment systems, digital wallets, credit card gateways) via a payment processing component. The actual interactions with the payment gateways 106 may be provided through a card server environment. At the end of the checkout process, an order is created. An order is a contract of sale between the merchant and the customer where the merchant agrees to provide the goods and services listed on the order (e.g., order line items, shipping line items, and the like) and the customer agrees to provide payment (including taxes). Once an order is created, an order confirmation notification may be sent to the customer and an order placed notification sent to the merchant via a notification component. Inventory may be reserved when a payment processing job starts to avoid over-selling (e.g., merchants may control this behavior using an inventory policy or configuration for each variant). Inventory reservation may have a short time span (minutes) and may need to be fast and scalable to support flash sales or “drops”, which are events during which a discount, promotion or limited inventory of a product may be offered for sale for buyers in a particular location and/or for a particular (usually short) time. The reservation is released if the payment fails. When the payment succeeds, and an order is created, the reservation is converted into a permanent (long-term) inventory commitment allocated to a specific location. An inventory component of the commerce management engine 136 may record where variants are stocked, and may track quantities for variants that have inventory tracking enabled. It may decouple product variants (a customer-facing concept representing the template of a product listing) from inventory items (a merchant-facing concept that represents an item whose quantity and location is managed). An inventory level component may keep track of quantities that are available for sale, committed to an order or incoming from an inventory transfer component (e.g., from a vendor).

The merchant may then review and fulfill (or cancel) the order. A review component of the commerce management engine 136 may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) before it marks the order as paid. The merchant may now prepare the products for delivery. In some embodiments, this business process may be implemented by a fulfillment component of the commerce management engine 136. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. Alternatively, an API fulfillment service may trigger a third-party application or service to create a fulfillment record for a third-party fulfillment service. Other possibilities exist for fulfilling an order. If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date-based ledger that records sale-related events that happened to an item).

### Implementations

The methods and systems described herein may be deployed in part or in whole through a machine that executes computer software, program codes, and/or instructions on a processor. The processor may be part of a server, cloud server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In some embodiments, the process may be a dual core processor, quad core processors, other chip-level multiprocessor and the like that combine two or more independent cores (called a die).

The methods and systems described herein may be deployed in part or in whole through a machine that executes computer software on a server, cloud server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented in different devices which may operate in wired or wireless networks. Examples of wireless networks include 4th Generation (4G) networks (e.g., Long-Term Evolution (LTE)) or 5th Generation (5G) networks, as well as non-cellular networks such as Wireless Local Area Networks (WLANs). However, the principles described therein may equally apply to other types of networks.

The operations, methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another, such as from usage data to a normalized usage dataset.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable devices, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above, and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

1. A computer-implemented method comprising:
storing a plurality of digital assets for use in blocks of a website;
for a digital asset from among the plurality of digital assets, storing data indicative of one or more blocks of the website that use the digital asset; and
generating data representative of a Graphical User Interface (GUI) for a website builder function for building the website, the GUI comprising:
a first GUI element that represents the digital asset; and
one or more second GUI elements that are associated with the first GUI element and are indicative of the one or more blocks of the website that use the digital asset.

2. The method of claim 1, further comprising:
for the digital asset, updating the data indicative of the one or more blocks of the website that use the digital asset to add an additional block of the website that uses the digital asset; and
updating the data representative of the GUI for the website builder function for editing the website such that the one or more second GUI elements are further indicative of the additional block of the website that uses the digital asset.

3. The method of claim 2, further comprising:
receiving input that causes the digital asset to be used in the additional block of the website;
wherein updating that data representative of the GUI for the website builder function for editing the website such that the one or more second GUI elements are further indicative of the additional block of the website that uses the digital asset is performed responsive to the digital asset being used in the additional block of the website.

4. The method of claim 1, further comprising sending the data representative of the GUI for the website builder function to a remote device to cause the GUI to be presented on a display of the remote device.

5. The method of claim 1, further comprising causing the GUI for the website builder function to be displayed in accordance with the data representative of the GUI for the website builder function.

6. The method of claim 1, wherein the one or more blocks of the website that use the digital asset comprise any one or more of the following:
one or more webpages of the website;
one or more meta-objects used in the website; and
one or more blocks used in webpages of the website.

7. The method of claim 1, wherein the one or more blocks of the website comprise two or more types of blocks, and the one or more second GUI elements are indicative of the two or more types of blocks.

8. The method of claim 1, wherein the digital asset is a digital image, a digital video, a 3-Dimensional (3D) model, a point cloud, or a Gaussian splat.

9. A computing system, the computing system comprising:
processing circuitry; and
memory comprising instructions executed by the processing circuitry, whereby the computing system is operable to:
store a plurality of digital assets for use in blocks of a website;
for a digital asset from among the plurality of digital assets, store data indicative of one or more blocks of the website that use the digital asset; and
generate data representative of a Graphical User Interface (GUI) for a website builder function for building the website, the GUI comprising:
a first GUI element that represents the digital asset; and
one or more second GUI elements that are associated with the first GUI element and are indicative of the one or more blocks of the website that use the digital asset.

10. The computing system of claim 9, wherein, by execution of the instructions comprised in the memory by the processing circuitry, the computing system is further operable to:
for the digital asset, update the data indicative of the one or more blocks of the website that use the digital asset to add an additional block of the website that uses the digital asset; and
update that data representative of the GUI for the website builder function for editing the website such that the one or more second GUI elements are further indicative of the additional block of the website that uses the digital asset.

11. The computing system of claim 10, wherein, by execution of the instructions comprised in the memory by the processing circuitry, the computing system is further operable to:
receive input that causes the digital asset to be used in the additional block of the website;
wherein updating the data representative of the GUI for the website builder function for editing the website such that the one or more second GUI elements are further indicative of the additional block of the website that uses the digital asset is performed responsive to the digital asset being used in the additional block of the website.

12. The computing system of claim 9, wherein, by execution of the instructions comprised in the memory by the processing circuitry, the computing system is further operable to send the data representative of the GUI for the website builder function to a remote device to cause the GUI to be presented on a display of the remote device.

13. The computing system of claim 9, wherein, by execution of the instructions comprised in the memory by the processing circuitry, the computing system is further operable to cause the GUI for the website builder function to be displayed in accordance with the data representative of the GUI for the website builder function.

14. The computing system of claim 9, wherein the one or more blocks of the website that use the digital asset comprise any one or more of the following:
one or more webpages of the website;
one or more meta-objects used in the website; and
one or more blocks used in webpages of the website.

15. The computing system of claim 9, wherein the one or more blocks of the website comprise two or more types of blocks, and the one or more second GUI elements are indicative of the two or more types of blocks.

16. The computing system of claim 9, wherein the digital asset is a digital image, a digital video, a 3-Dimensional (3D) model, a point cloud, or a Gaussian splat.

17. A non-transitory computer-readable medium storing instructions executable by processing circuitry of a computing system whereby the computing system is operable to:
store a plurality of digital assets for use in blocks of a website;
for a digital asset from among the plurality of digital assets, store data indicative of one or more blocks of the website that use the digital asset; and
generate data representative of a Graphical User Interface (GUI) for a website builder function for building the website, the GUI comprising:
a first GUI element that represents the digital asset; and
one or more second GUI elements that are associated with the first GUI element and are indicative of the one or more blocks of the website that use the digital asset.
